(19) United States
(12) Patent Application Publication
(10) Pub. No.: US 2025/0341365 A1
(43) Pub. Date: Nov. 6, 2025

(54) PILOT BURNER HOT SURFACE IGNITER APPARATUS,SYSTEMS, AND METHODS

(71) Applicant: OXBOW CALCINING LLC, West Palm Beach, FL (US)

(72) Inventors: Ryan PISCOPO, Baton Rouge, LA (US); Jeremy TOOMAN, Enid, OK (US); Brandon SUTTON, Enid, OK (US); Jonathan TONNELL, Lynchburg, VA (US)

(21) Appl. No.: 19/268,167

(22) Filed: Jul. 14, 2025

Related U.S. Application Data
(63) Continuation of application No. PCT/US24/12110, filed on Jan. 19, 2024.
(60) Provisional application No. 63/481,421, filed on Jan. 25, 2023.

(51) Int. Cl. F27B 7/34; C10B 57/00; F23Q 7/10; F27B 7/10

(52) U.S. Cl. CPC F27B 7/34; C10B 57/005; F23Q 7/10; F27B 7/10; F27M 2001/045; F27M 2003/03

(57) ABSTRACT

The present disclosure provides, inter alia, an apparatus, system, and method for applying heat to a rotary kiln using a pilot burner hot surface igniter.

### CROSS REFERENCE TO RELATED APPLICATIONS

The present application is a continuation of PCT International Application No. PCT/US24/12110 filed on Jan. 19, 2024, which claims benefit to U.S. Provisional Patent Application No. 63/481,421, filed Jan. 25, 2023, which applications are incorporated by reference herein in their entireties.

### BACKGROUND

Petroleum coke (petcoke) is a byproduct of the oil refining process. As refineries worldwide seek to operate more efficiently and extract more gasoline and other high value fuels from each barrel of crude oil, a solid carbon material known as petcoke is produced. The physical and chemical characteristics of petcoke are a function of the crude oil and refining technology used by the refinery. Physically, petcoke can be hard or relatively soft. It can resemble large sponges with numerous pores, or it can resemble small spheres, ranging in size from a grain of sand to a large marble. Chemically, petcoke can include a variety of elements and metals in a wide range of concentrations. Depending on these physical and chemical characteristics, petcoke is typically used either in an energy application as a source of British Thermal Units (BTUs), or in an industrial application as a source of carbon.

Calcining of petcoke is commonly performed in a rotary kiln into which green petroleum coke in particulate form is fed at one end and calcined product falls out at the other end. During the calcining process in the rotary kiln, high temperature drives off volatile compounds and moisture in the green coke, and shrinks it to achieve a desired density. The calcining process requires adequate heating to achieve a high production rate, while preferably minimizing or eliminating combustion of the carbon in the petcoke itself. The green coke entering the feed end of the tubular kiln flows down the kiln at a rate that depends, in large part, on the slope of the kiln drum, the diameter of the kiln drum, and on the speed of rotation of the kiln drum.

It is common to supply heat to the petcoke by firing with oil or natural gas burners directly into the lower end of the kiln. The flame from combusted natural gas or oil is projected into the kiln, where the hot gases flow up the kiln as a countercurrent to the descending bed of petcoke. Unfortunately, initiating and maintaining a flame to supply heat to the petcoke bed can be challenging. In a typical system, a spark igniter transformer is used to ignite the fuel, which has many drawbacks. For example, the use of a transformer runs the risk of the device shorting to ground, causing the transformer to prematurely fail. The spark igniter also comprises an energized electrode and grounding rod, which require a tight tolerance gap to function. If the gap is altered past tolerance, the system will not function properly. Furthermore utilizing a spark system provides a smaller heat/ignition source, requiring a more precise air/fuel mixture (e.g. ambient blown air and natural gas). As a result of these deficiencies, many hours of coke productivity can be lost while trying to obtain a flame. Moreover, current ignition systems require frequent maintenance and/or replacement due to the extreme temperatures the system is subjected to in and around the kiln. Thus, there exists need for an improved ignition system for use in, inter alia, a rotary kiln for production of petcoke.

### SUMMARY OF THE DISCLOSURE

According to some aspects, the present disclosure provides a pilot burner igniter apparatus comprising: a first tubing having a proximal end and a distal end, the proximal end of the first tubing functional to receive a fuel/air mixture and the distal end of the first tubing functional to allow emission of a flame; and a hot surface igniter disposed inside the first tubing between the proximal end and the distal end at a position that is directly in the path of the fuel/air mixture, the hot surface igniter comprising a first end and a second end, where the first end is operably connected to a power source and the second end comprises a heating element; wherein the hot surface igniter is disposed in the first tubing at an angle that is effective to place the heating element in the path of the fuel/air mixture; and wherein the hot surface igniter is disposed inside the first tubing between the proximal end and the distal end at a position that is effective to minimize heating of the hot surface igniter.

In some embodiments, the pilot burner igniter apparatus further comprises a support brace disposed inside the first tubing that is effective to hold the hot surface igniter at the angle that is effective to place the heating element in the path of a fuel/air mixture. In some embodiments, the pilot burner igniter apparatus disclosed herein further comprises a fuel pipe disposed within the first tubing, the fuel pipe having a proximal end and a distal end, the proximal end of the fuel pipe located at the proximal end of the first tubing and effective to receive fuel/air mixture and the distal end of the fuel pipe located adjacent to the hot surface igniter disposed inside the first tubing, wherein the fuel pipe is effective to blow fuel/air mixture over the heating element of the hot surface igniter. In some embodiments, the support brace further comprises a notch to receive the fuel pipe.

In some embodiments, the first tubing further comprises a threaded region that is effective to be separated by unscrewing and effective to be re-connected by screwing, wherein the threaded region is adjacent to the hot surface igniter and is effective to allow access to the hot surface igniter. In some embodiments, the hot surface igniter is disposed between 1 foot and 5 feet away from the distal end of the first tubing. In some embodiments, the hot surface igniter is disposed between 1 foot and 3 feet away from the distal end of the first tubing. In some embodiments, the hot surface igniter is disposed about 2 feet away from the distal end of the first tubing.

In some embodiments, the support brace is effective to hold the hot surface igniter at an angle of between 89-69 degrees relative to the wall of the first tubing. In some embodiments, the support brace is effective to hold the hot surface igniter at an angle of about 79 degree relative to the wall of the first tubing.

In some embodiments, the hot surface igniter is effective to ignite and maintain ignition of natural gas/air mixture.

According to some aspects, the present disclosure provides, a rotary kiln system comprising: a rotary kiln defining a cylindrical interior chamber that is effective to convey a material from a distal end to a proximal end of the rotary kiln; a hood disposed on the proximal end of the rotary kiln; and a pilot burner igniter apparatus, the pilot burner igniter apparatus comprising: a first tubing having a proximal end and a distal end, the proximal end of the first tubing functional to receive a fuel/air mixture and the distal end of the first tubing functional to allow emission of a flame; and a hot surface igniter disposed inside the first tubing between the proximal end and the distal end at a position that is directly in the path of the fuel/air mixture, the hot surface igniter comprising a first end and a second end, where the first end is operably connected to a power source and the second end comprises a heating element; wherein the hot surface igniter is disposed in the first tubing at an angle that is effective to place the heating element in the path of the fuel/air mixture; wherein the hot surface igniter is disposed inside the first tubing between the proximal end and the distal end at a position that is effective to minimize heating of the hot surface igniter; wherein the distal end of the first tubing of the pilot burner igniter apparatus is disposed through the hood and adjacent to the proximal end of the rotary kiln and is effective to emit a flame into the proximal end of the rotary kiln.

In some embodiments, the rotary kiln system as disclosed herein further comprises a rail system connected to the pilot burner igniter apparatus that is effective to move the first tubing through the hood. In some embodiments, the first tubing of the pilot burner igniter apparatus is capable of being moved to different positions through the hood. In some embodiments, the rotary kiln system as disclosed herein comprises a support brace disposed inside the first tubing that is effective to hold the hot surface igniter at the angle that is effective to place the heating element in the path of a fuel/air mixture.

In some embodiments, the rotary kiln system as disclosed herein comprises a fuel pipe disposed within the first tubing, the fuel pipe having a proximal end and a distal end, the proximal end of the fuel pipe located at the proximal end of the first tubing and effective to receive fuel/air mixture, and the distal end of the fuel pipe located adjacent to the hot surface igniter disposed inside the first tubing, wherein the fuel pipe is effective to blow fuel/air mixture over the heating element of the hot surface igniter. In some embodiments, the support brace further comprises a notch to receive the fuel pipe.

In some embodiments, the first tubing further comprises a threaded region that is effective to be separated by unscrewing and effective to be re-connected by screwing, wherein the threaded region is adjacent to the hot surface igniter and is effective to allow access to the hot surface igniter. In some embodiments, the hot surface igniter is disposed between 1 foot and 5 feet away from the distal end of the first tubing. In some embodiments, the hot surface igniter is disposed between 1 foot and 3 feet away from the distal end of the first tubing. In some embodiments, the hot surface igniter is disposed about 2 feet away from the distal end of the first tubing.

In some embodiments, the support brace is effective to hold the hot surface igniter at an angle of between 89-69 degrees relative to the wall of the first tubing. In some embodiments, the support brace is effective to hold the hot surface igniter at an angle of about 79 degrees relative to the wall of the first tubing. In some embodiments, the hot surface igniter is effective to ignite and maintain ignition of natural gas/air mixture.

According to some aspects, the present disclosure provides a method for production of calcined coke, comprising the steps of charging and conveying coke through the rotary kiln system as disclosed herein.

### BRIEF DESCRIPTION OF THE DRAWINGS

FIG. 1 shows a cross sectional side view of some embodiments of the apparatus as disclosed herein.

FIG. 2 shows a cross sectional side view of some embodiments of the apparatus as disclosed herein.

FIG. 3 shows a top view of the pilot burner igniter support brace according to some embodiments as disclosed herein.

FIG. 4A shows a top view of the pilot burner igniter support brace according to some embodiments disclosed herein. FIG. 4B shows a perspective view of the pilot burner igniter support brace according to some embodiments as disclosed herein.

FIG. 5A shows a top view of the pilot burner igniter support brace according to some embodiments disclosed herein. FIG. 5B shows a top view of the pilot burner igniter support brace according to some embodiments disclosed herein. FIG. 5C shows a top view of the pilot burner igniter support brace according to some embodiments disclosed herein.

FIG. 6A shows a cross sectional side view of the pilot burner igniter according to some embodiments as disclose herein. FIG. 6B shows a transparent perspective view of the pilot burner igniter according to some embodiments disclosed herein.

FIG. 7 shows a cross sectional side view of the pilot burner igniter according to some embodiments disclosed herein.

FIG. 8 shows a perspective view of the pilot burner igniter according to some embodiments disclosed herein.

FIG. 9 shows a top down perspective view of the pilot burner igniter according to some embodiments disclosed herein.

FIG. 10 shows a system configuration according to some embodiments of the system as disclosed herein.

FIG. 11 shows a top view of the pilot burner igniter system according to some embodiments disclosed herein.

FIG. 12 shows a cross sectional side view of the pilot burner igniter system according to some embodiments disclosed herein.

FIG. 13 shows a top down perspective view of the pilot burner igniter system according to some embodiments disclosed herein.

FIG. 14 shows a cross sectional side view of the pilot burner igniter system according to some embodiments disclosed herein.

FIG. 15 shows a rear view of the pilot burner igniter system according to some embodiments disclosed herein.

FIG. 16 shows a cross sectional side view of the pilot burner igniter system according to some embodiments disclosed herein with burner in fully inserted position.

FIG. 17 shows a cross sectional side view of the pilot burner igniter system according to some embodiments disclosed herein with burner in operational position.

FIG. 18 shows a cross sectional side view of the pilot burner igniter system according to some embodiments disclosed herein with burner in retracted position.

FIG. 19 shows a cross sectional side view of the pilot burner igniter system according to some embodiments disclosed herein with hood and burner in retracted (maintenance) position.

FIG. 20 shows a front view of the pilot burner igniter system according to some embodiments disclosed herein.

FIG. 21 shows a rear view of the pilot burner igniter system according to some embodiments disclosed herein.

FIG. 22 shows a perspective view of the pilot burner igniter system according to some embodiments disclosed herein.

FIG. 23 shows a cross sectional side view of the pilot burner igniter system according to some embodiments disclosed herein.

FIG. 24 shows a side view of the pilot burner igniter system according to some embodiments disclosed herein.

FIG. 25 shows a parts list for FIGS. 20-24.

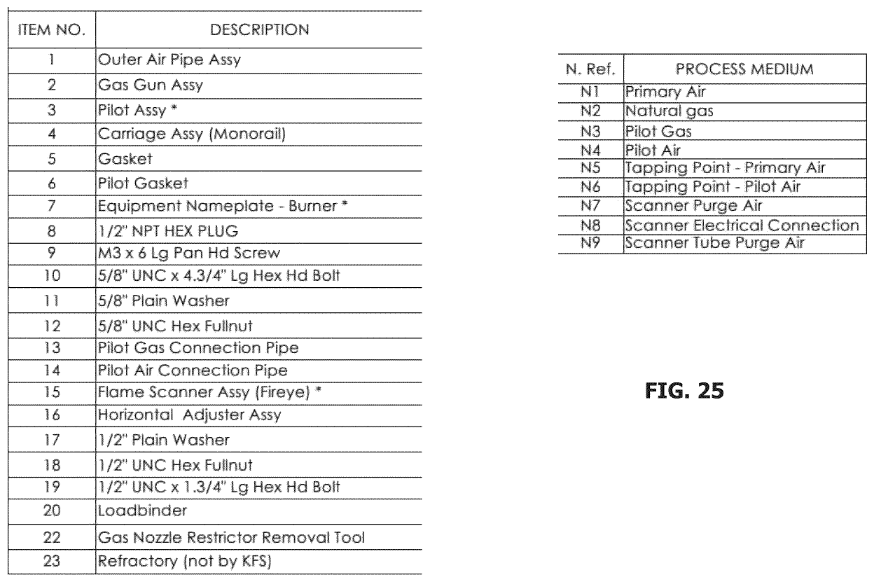

FIG. 26 shows the results of testing the pilot burner igniter apparatus and system according to some embodiments disclosed herein.

### DETAILED DESCRIPTION

According to some aspects, the present disclosure provides an apparatus, system and/or method for a pilot burner ignition system useful with a pilot burner for calcining material in a rotary kiln.

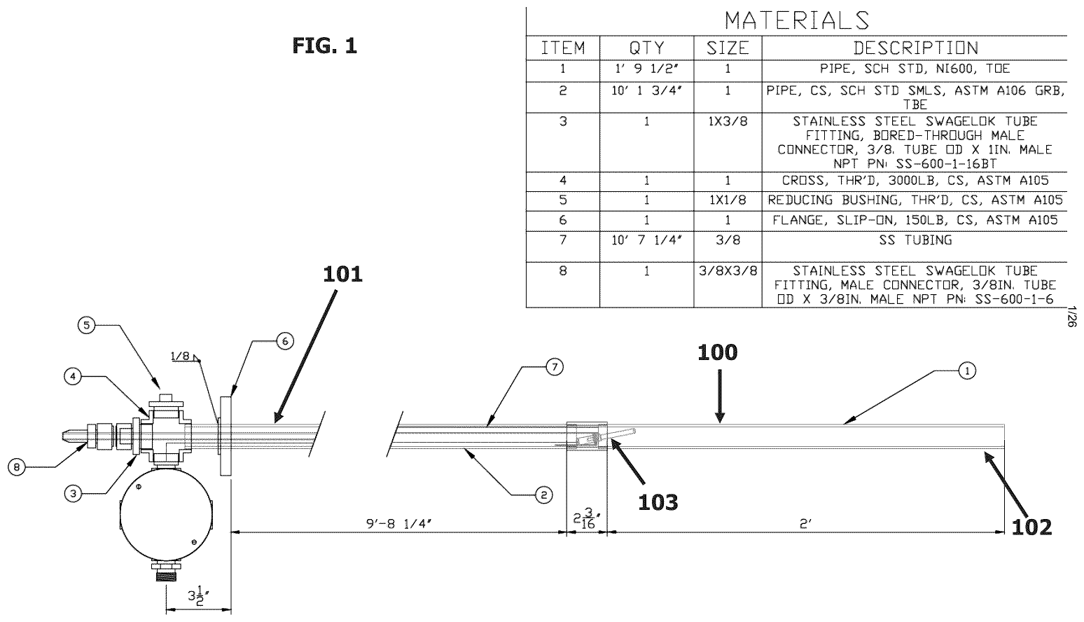

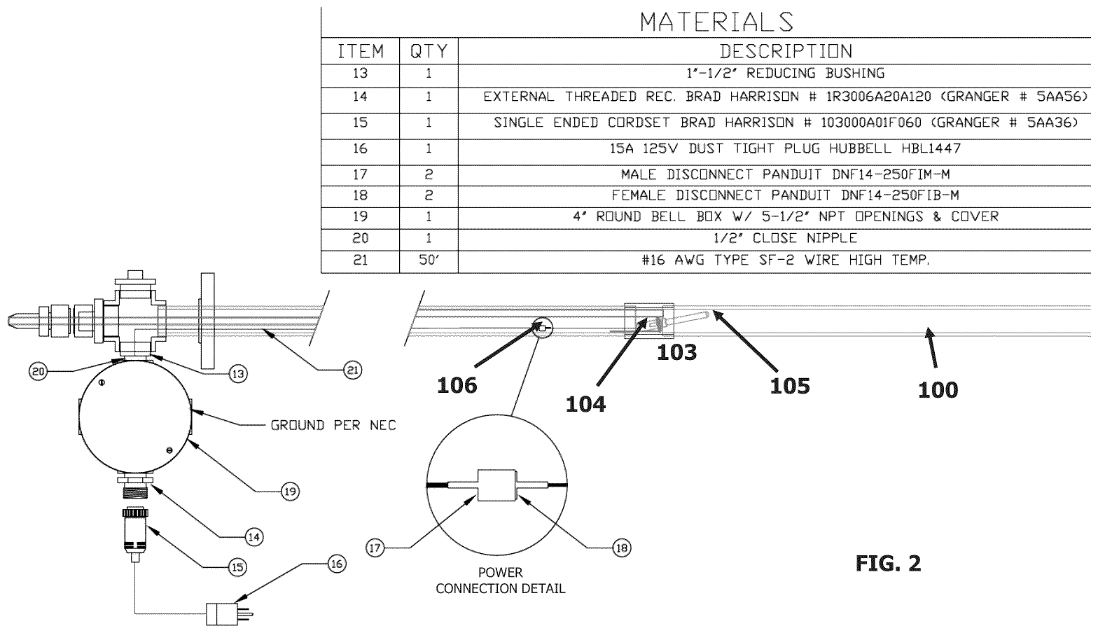

As shown in FIG. 1, according to some aspects, the present disclosure provides a pilot burner igniter apparatus comprising a first tube 100 having a proximal end 101 and a distal end 102. In some embodiments, the proximal end of the first tubing 101 is functional to receive a fuel or a fuel/air mixture, such as ambient air and natural gas. In some embodiments, the proximal end of the first tubing 101 is functional to receive air and/or other gas. In some embodiments, the distal end of the first tubing 102 is functional to allow emission of a flame. As seen in FIGS. 1 and 2, in some embodiments, a hot surface igniter 103 is disposed inside the first tubing 100 between the proximal end 101 and the distal end 102. In some embodiments, the hot surface igniter 103 is located at a position that is directly in the path of a fuel/air mixture. As seen in FIG. 2, in some embodiments the hot surface igniter 103 comprises a first end 104 and a second end 105, where the first end 104 is operably connected to a power source and the second end 105 comprises a heating element. As seen in FIG. 2, in some embodiments, a power connection 106 is also disposed inside tubing 100.

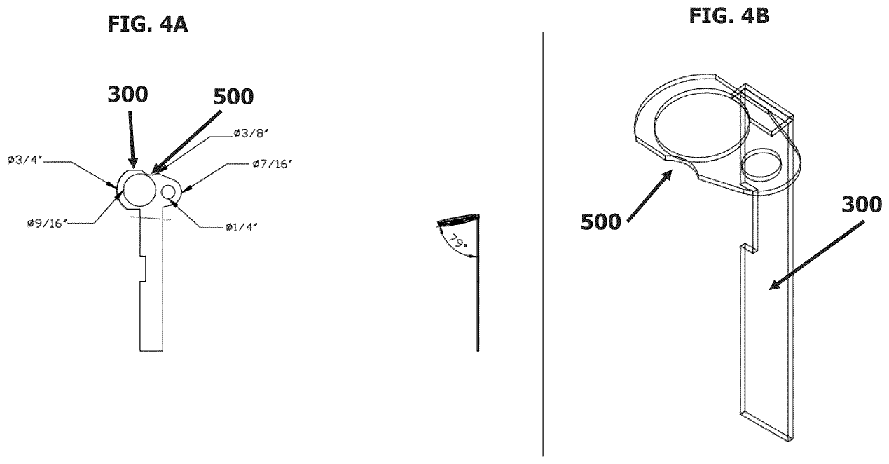

As seen in FIGS. 1 and 2, in some embodiments the hot surface igniter 103 is disposed inside tubing 100 at an angle. In some embodiments, the angle of the hot surface igniter 103 is selected to place the heating element of the hot surface igniter 103 into the path of fuel. In some embodiments, placing the heating element of the hot surface igniter 103 directly in the path of fuel creates turbulence, which aids in combustion of the fuel. In some embodiments, the angle of the heating element of the hot surface igniter 103 is between 89-69 degrees relative to the interior wall of tubing 100. (For reference, a 90 degree angle places the heating element parallel with the wall of the tubing 100; See FIG. 4A). In some embodiments, this range is established based on the hot surface ignitor's positive interference with the flow of gas from the gas tube. In some embodiments, the angle of the heating element of the hot surface igniter is effective to allow both the gas and the air to pass across the hot surface ignitor, establishing consistent ignition.

In some embodiments, the hot surface igniter 103 is disposed inside tubing 100 between the proximal end 101 and the distal end 102 at a position that is effective to minimize heating of the hot surface igniter. As shown in FIG. 1, in some embodiments, the hot surface igniter 103 is disposed about two feet away from the distal end 102 of tube 100. In some embodiments, tubing 100 comprises two separate halves (a first half on the distal end 101 and second half on the proximal end 102), with the hot surface igniter 103 disposed at the approximate interface of the two halves. In some embodiments, the immediate end of a fuel pipe 400 is disposed at the approximate interface of the two halves. In some embodiments, the hot surface igniter 103 is located at the immediate end of the fuel pipe 400. In some embodiments, the location where fuel contacts the hot surface igniter 103 is the ignition point. In some embodiments, the tube 100 extends at least 12 inches, at least 18 inches, or at least 24 inches from the ignition point. In some embodiments, the tube 100 extends between 12 inches to 24 inches from the ignition point. In some embodiments, the tube 100 extends 18 inches from the ignition point. In some embodiments, the tube 100 extends 24 inches from the ignition point. In some embodiments, the distance that tube 100 extends past the ignition point is effective to prevent the hot surface igniter from being exposed to temperatures of greater than 150 degrees F. In some embodiments, the distance that tube 100 extends past the ignition point is effective to expose the hot surface igniter 103 to ambient temperature. In some embodiments, the position of the hot surface ignitor 103 is effective to expose it to less than 150 degrees F. when inserted into or adjacent to a kiln operating at greater than 2,000 degrees F. In some embodiments, tubing 100 further comprises an insulating material to protect the hot surface igniter from extreme temperature.

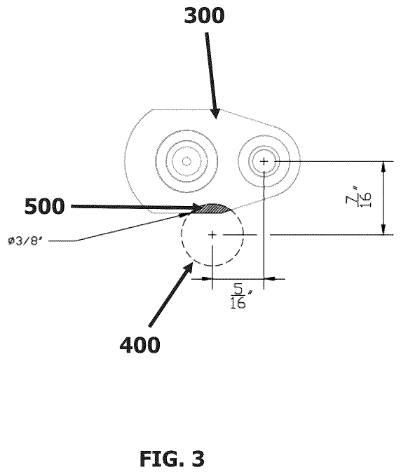

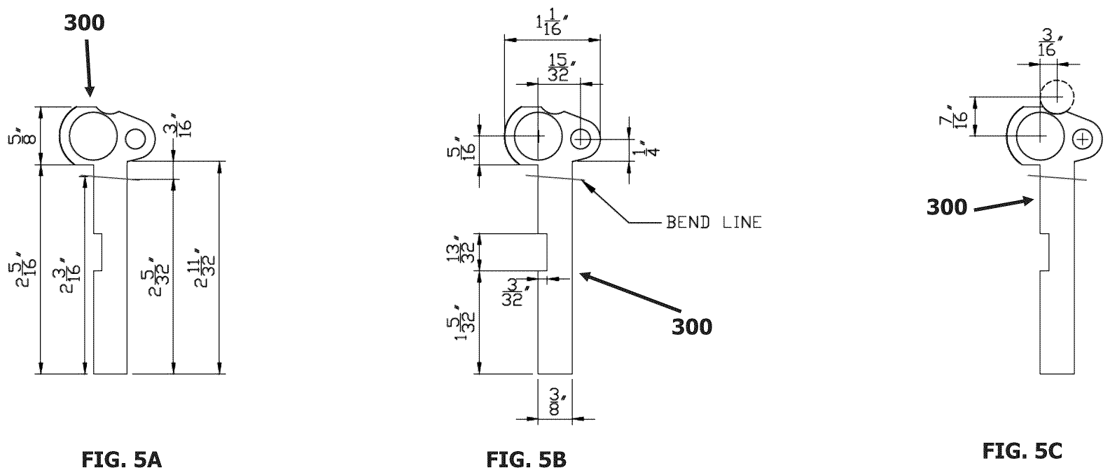

As shown in FIGS. 3-5, in some embodiments, the pilot burner igniter apparatus comprises a support brace 300 (a.k.a. ignitor mount) disposed inside the tubing 100 that is effective to hold the hot surface igniter 103 at the angle that is effective to place the heating element in the path of a fuel/air mixture.

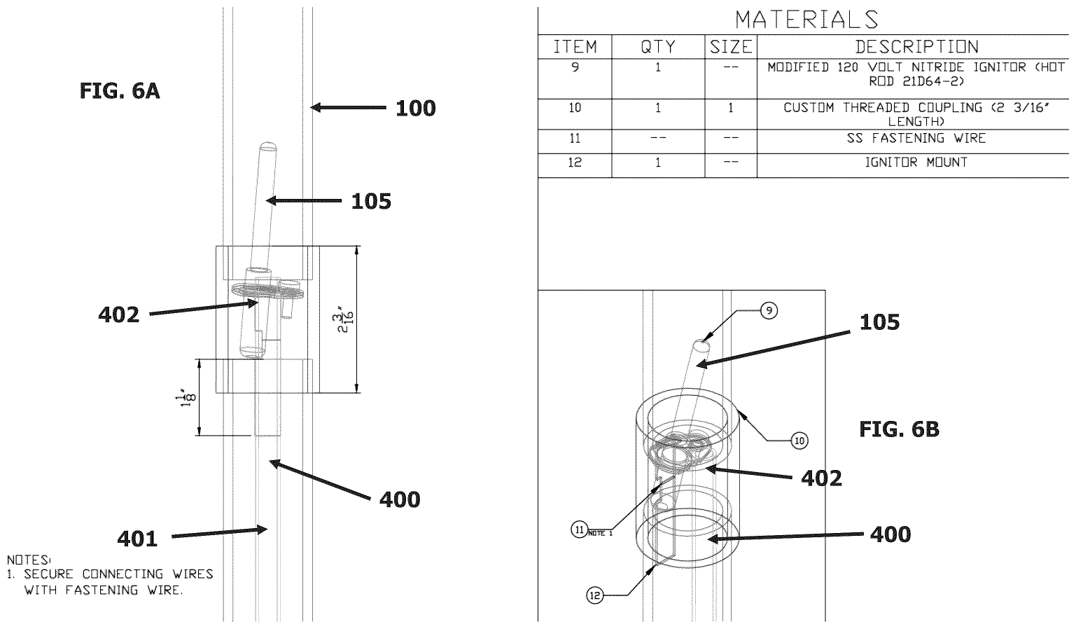

As shown in FIGS. 6A and 6B, in some embodiments, the pilot burner igniter apparatus comprises a fuel pipe 400. In some embodiments, the fuel pipe 400 is disposed inside tubing 100. As shown in FIG. 6A and 6B, in some embodiments, the fuel pipe has a proximal end 401 and a distal end 402. In some such embodiments, the proximal end of the fuel pipe 401 is located at the proximal end of the tubing 100 and is effective to receive fuel. In some embodiments, the proximal end of the fuel pipe 401 is effective to receive a fuel/air mixture, such as natural gas and blown ambient air, both at specific ranges of concentration. In some embodiments, a regulating device is used to control the concentration of fuel/air elements until the proper air/gas ratio range for combustion is met. In some embodiments, the distal end of the fuel pipe 402 is located adjacent to the hot surface igniter 103 disposed inside the tubing 100. As seen in FIGS. 6A and 6B, in some embodiments, the distal end of the fuel pipe 402 is positioned adjacent to the heating element of the hot surface igniter 103 effective to blow fuel/air (such as natural gas & blown ambient air, both at specific ranges of concentration) over the heating element of the hot surface igniter 103. As seen in FIGS. 3-5, in some embodiments, the support brace further comprises a notch 500 to receive the fuel pipe 400. In some embodiments, the notch 500 accommodates the fuel pipe to conserve space in the confines of tube 100.

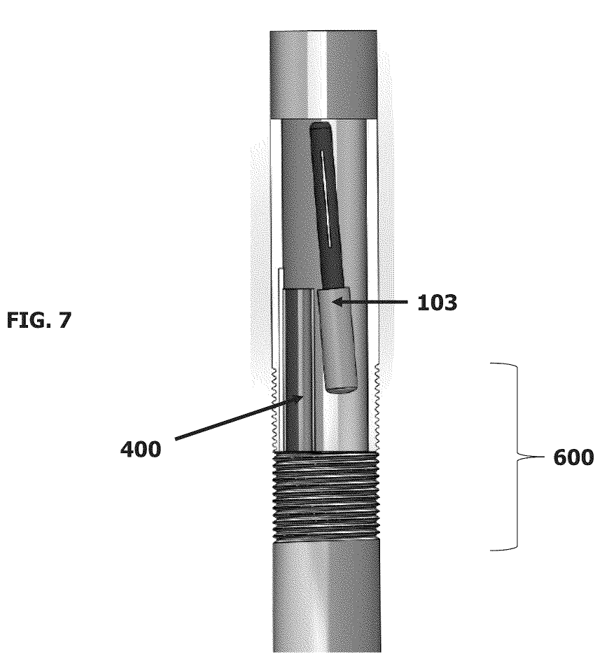

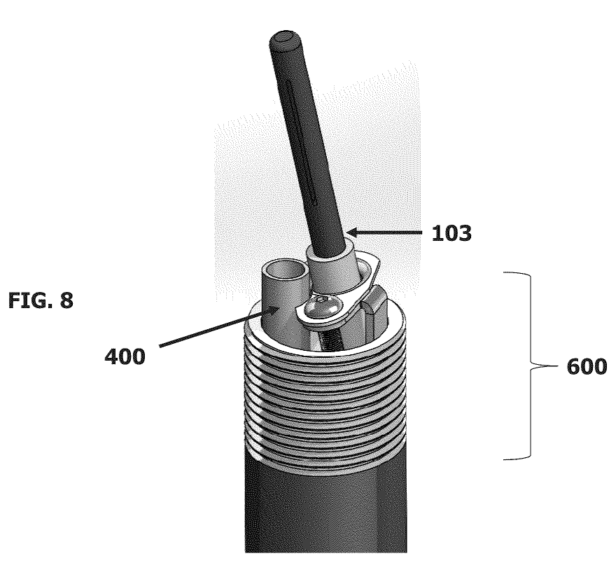

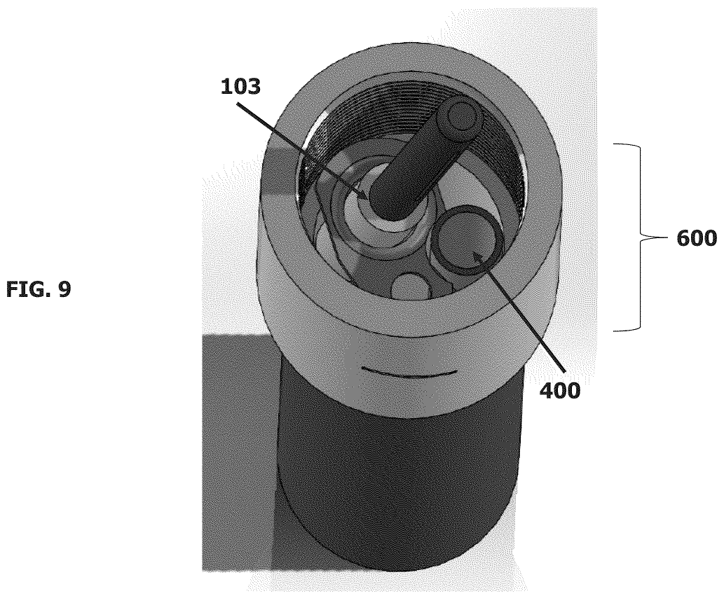

As shown in FIGS. 7-9, in some embodiments, the tubing 100 further comprises a threaded region 600 that can be screwed together and/or unscrewed, wherein the threaded region is adjacent to the hot surface igniter 103. In some embodiments, the threaded region 600 is effective to allow access to the hot surface igniter 103. In some embodiments, the threaded region 600 comprises one or more of male threaded parts and female threaded parts.

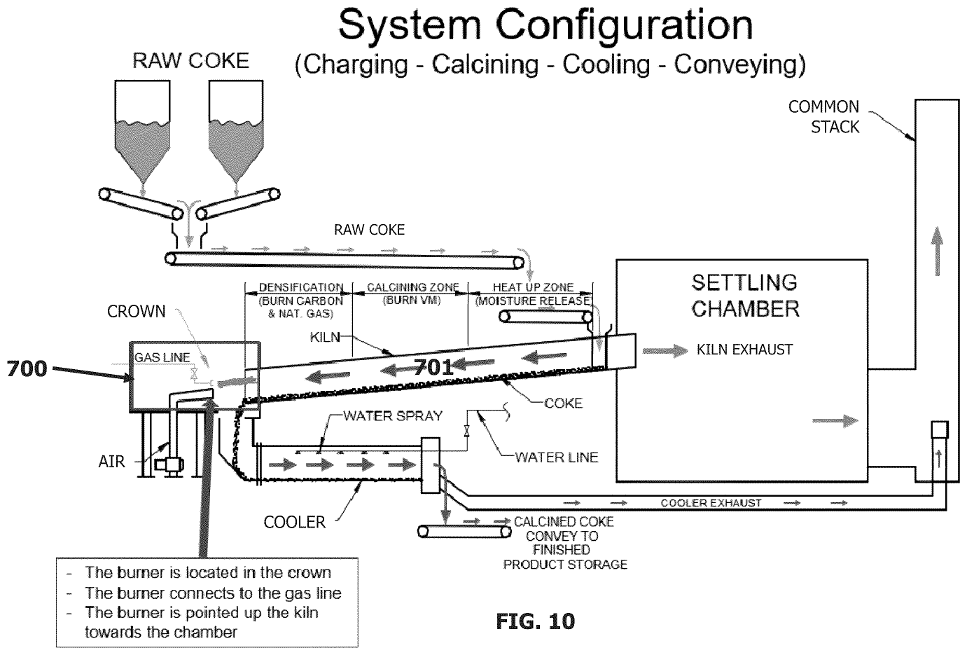

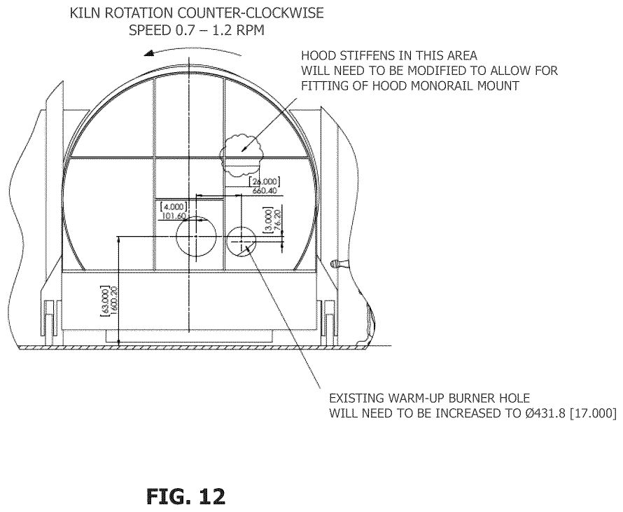

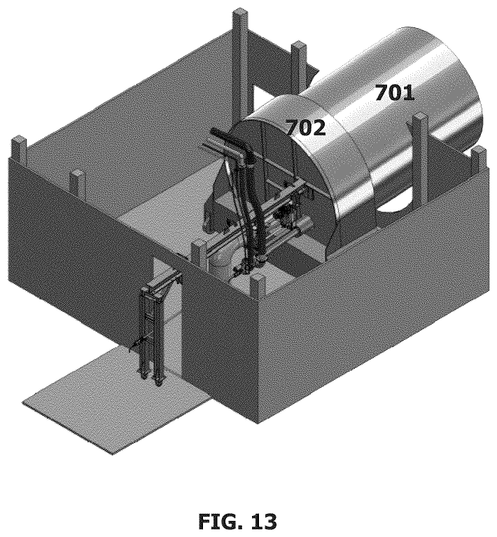

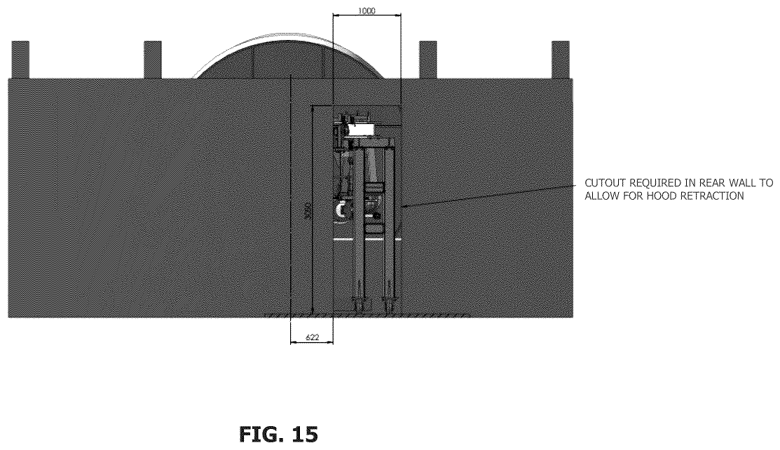

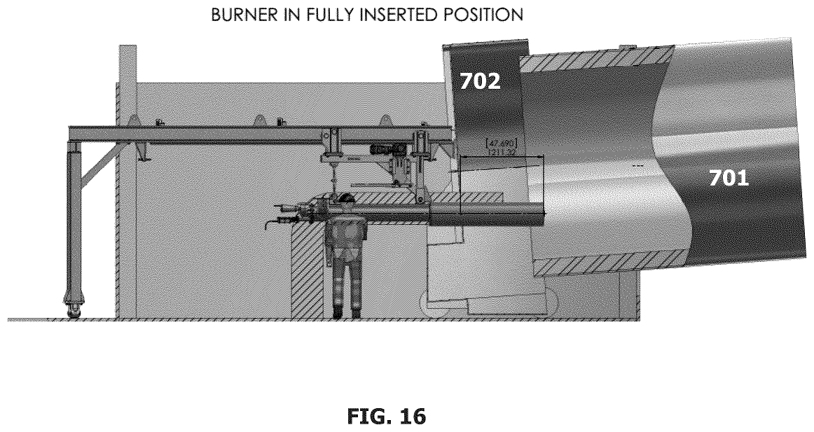

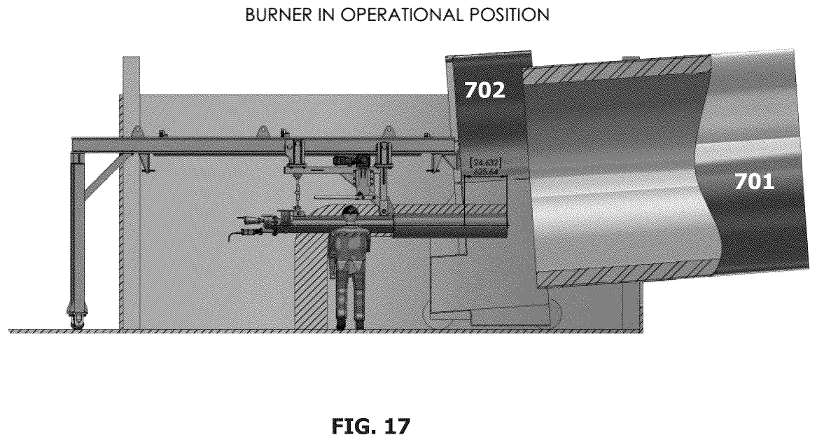

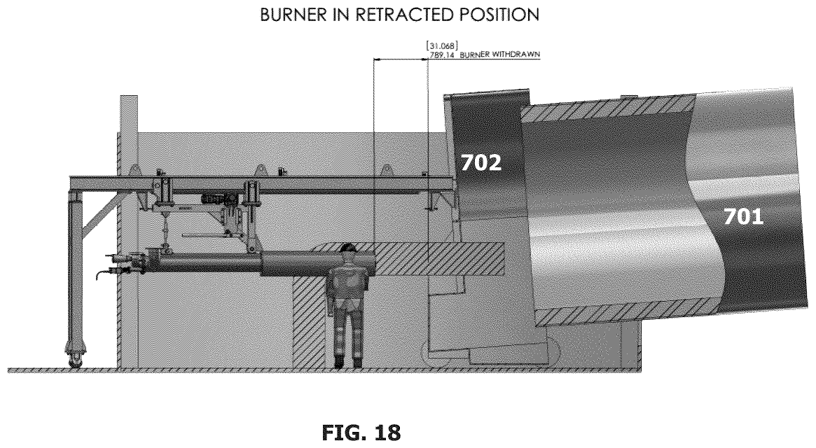

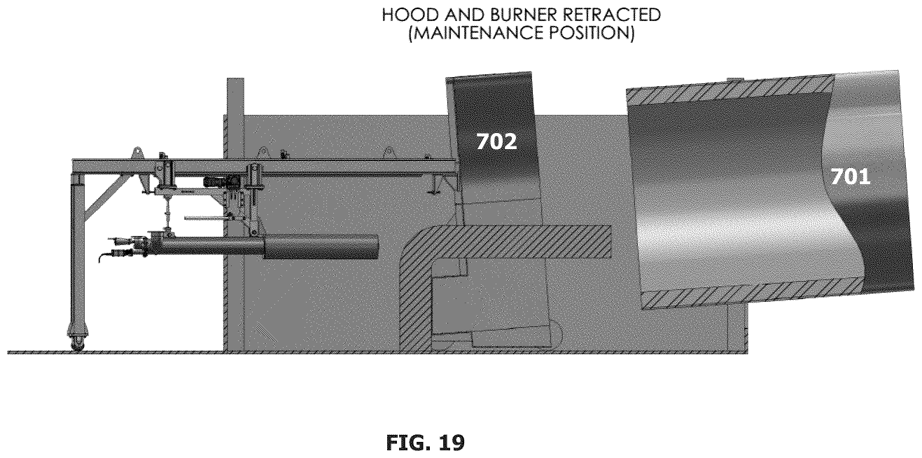

As shown in FIGS. 10-19, according to some aspects, the present disclosure provides the use of a pilot burner hot surface ignitor that is part of a larger system configuration for production of calcined material, such as calcined coke. As shown in FIG. 10, in some embodiments, the pilot burner region 700 where the pilot burner is disposed comprising tubing 100 and hot surface ignitor 103 (not shown) is adjacent to the rotary kiln 701. As shown in FIG. 10, raw coke is charged into the kiln 701 wherein the rotation of the kiln moves the coke through the heat up zone, calcining zone, and densification zone before being dropped into a cooler. As shown in FIG. 10, in some embodiments, a flame from the pilot burner is disposed inside the kiln to provide heat and gasses countercurrent to the flow of the bed of coke material.

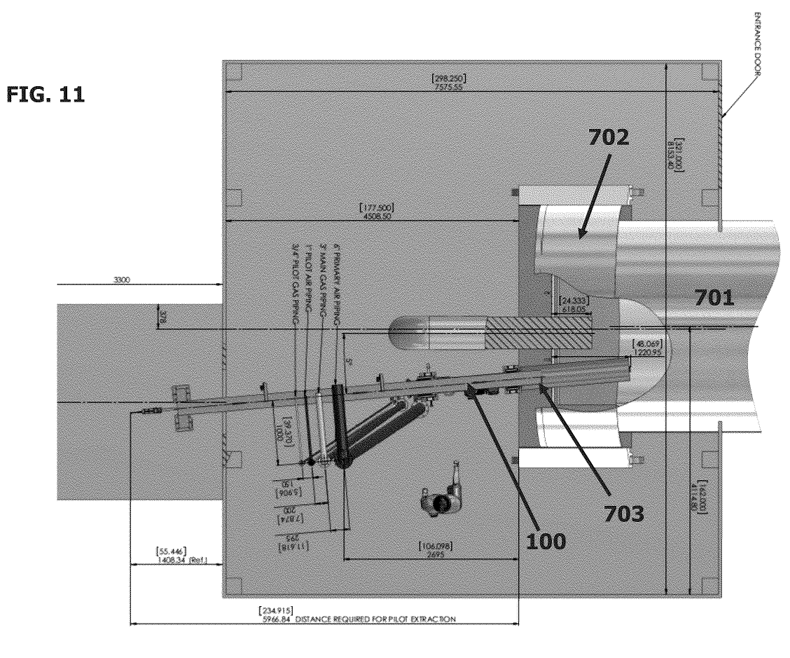

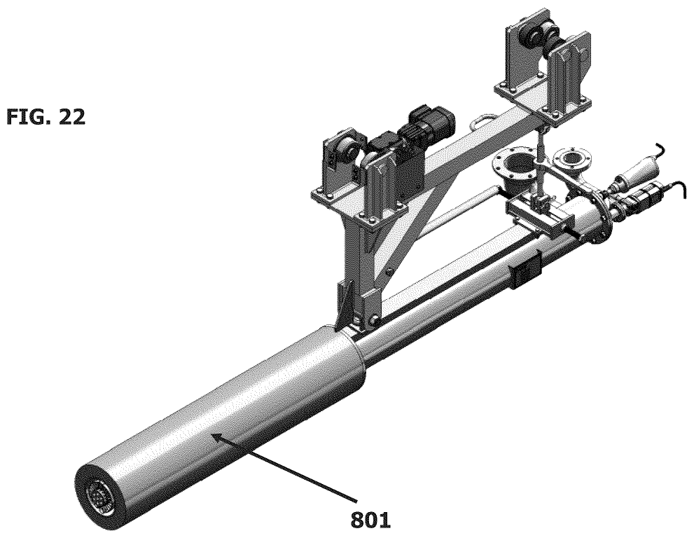

As shown in FIGS. 11-19, in some embodiments, the kiln 701 has a hood 702 disposed at the end the received the pilot burner. In some embodiments, the pilot burner is inserted through the hood 702 such that the distal end of tube 100 is adjacent to or inserted into the rotary kiln 701 to provide a flame. According to some embodiments, the hot surface igniter 103 is disposed at the interface of two halves of tubing 100 (indicated as 703). In some such embodiments, the end of tubing 100 disposed adjacent to or inside the kiln 701 is at a distance of about 24 inches from the hot surface igniter. In some embodiments, the tubing 100 further comprises a sheathing 801 to protect from extreme temperatures in the kiln (see FIG. 22).

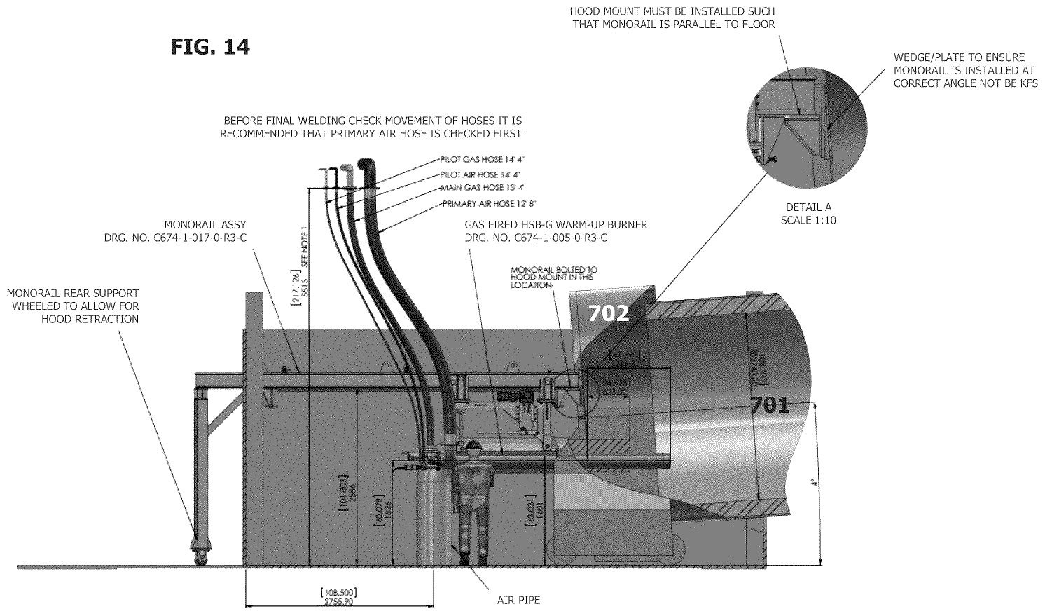

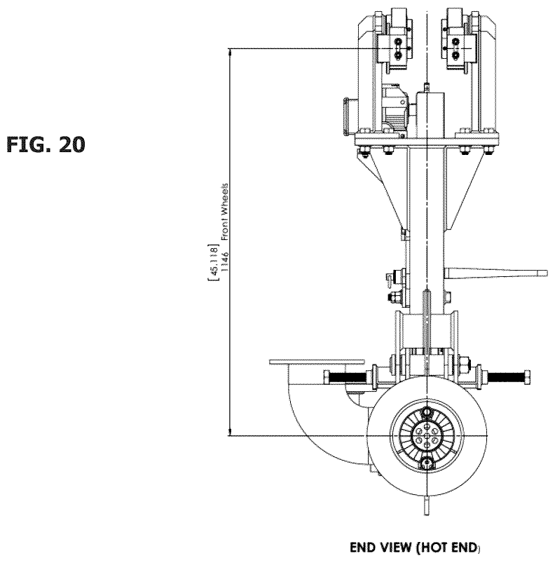

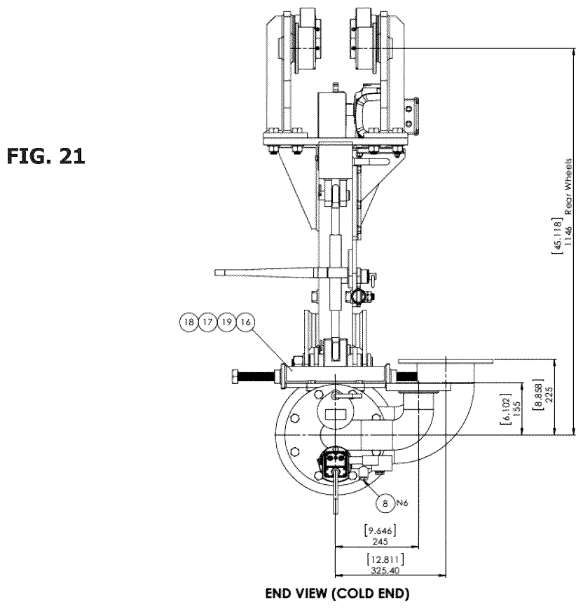

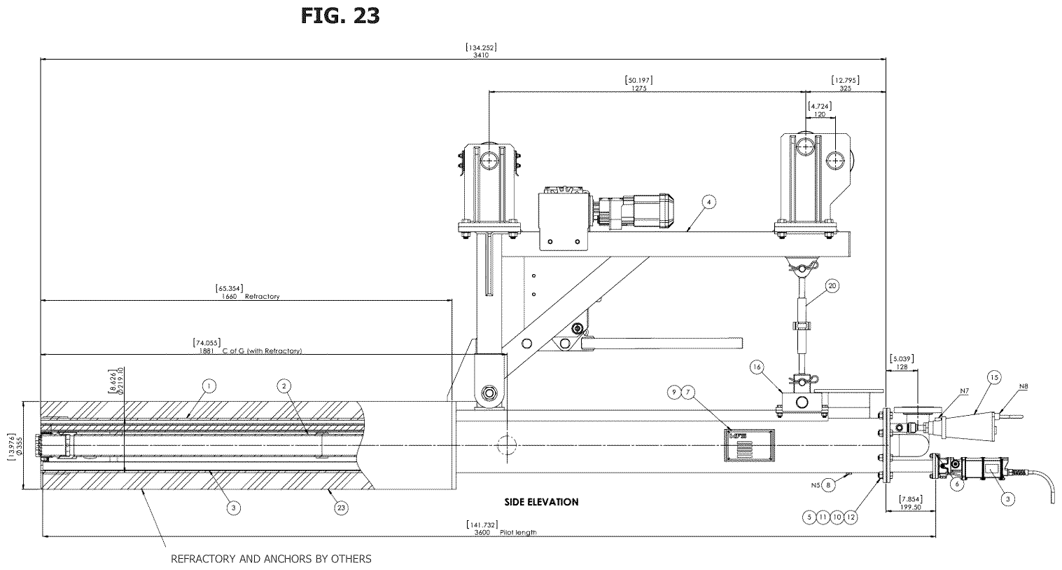

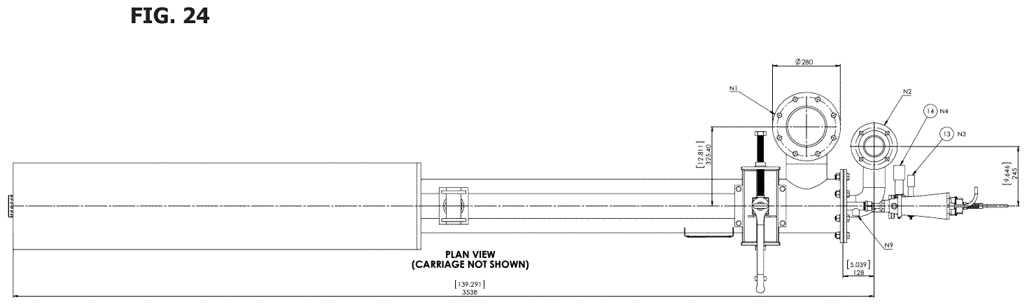

As shown in FIGS. 14-24, in some embodiments disclosed herein, the pilot burner is capable of being moved into various positions around the kiln 701.

In some embodiments, the various components of the apparatus and system disclosed herein by be made from mild steel or stainless steel. In some embodiments, the hot surface igniter may be a modified or unmodified Emerson “HotRod” Universal hot surface igniter, 120 VAC, 21D64-2.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly and not limited to the examples described in the present specification or during the prosecution of the application, which examples are to be construed as non-exclusive.

### EXAMPLES

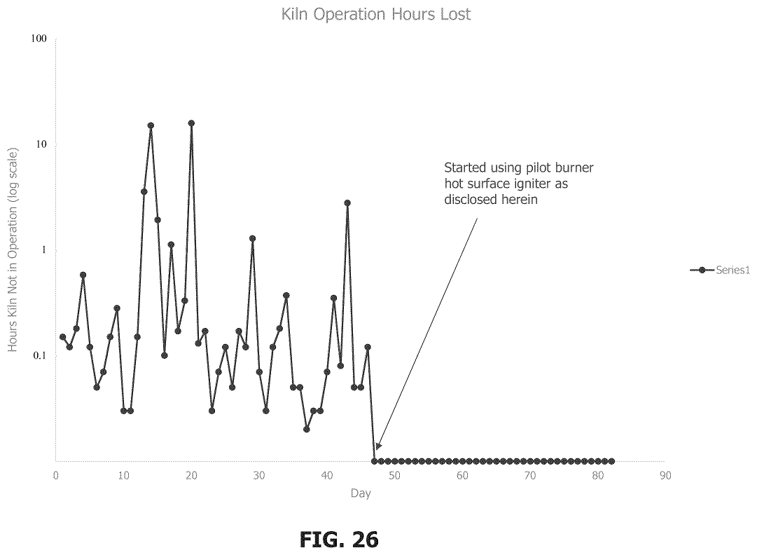

### EXAMPLE 1. As shown in FIG. 26, data was collected on the number of hours

lost for kiln operation on selected days using typical spark igniter transformer to generate pilot burner flame or the hot surface igniter pilot burner as disclosed herein to generate pilot burner flame. For each of the selected days using the spark igniter, the time of lost operation varied between several minutes and several hours. The total down time for the selected days amounted to about 46 hours lost. In contrast, after the pilot burner hot surface igniter as disclosed herein was installed, the time of lost operation of the kiln dropped to zero (See FIG. 26, arrow). Thus, it was surprisingly discovered that the pilot burner hot surface igniter as disclosed herein was able to effectively eliminate kiln operation down time due to lost flame.

Although illustrative embodiments of the present disclosure have been described herein, it should be understood that the disclosure is not limited to those described, and that various other changes or modification may be made by one of ordinary skill in the art without departing from the scope or spirit of the invention.

What is claimed is:

1. A pilot burner igniter apparatus comprising:
a first tubing having a proximal end and a distal end, the proximal end of the first tubing functional to receive a fuel/air mixture and the distal end of the first tubing functional to allow emission of a flame; and
a hot surface igniter disposed inside the first tubing between the proximal end and the distal end at a position that is directly in the path of the fuel/air mixture, the hot surface igniter comprising a first end and a second end, where the first end is operably connected to a power source and the second end comprises a heating element;
wherein the hot surface igniter is disposed in the first tubing at an angle that is effective to place the heating element in the path of the fuel/air mixture; and
wherein the hot surface igniter is disposed inside the first tubing between the proximal end and the distal end at a position that is effective to minimize heating of the hot surface igniter.

2. The pilot burner igniter apparatus of claim 1, further comprising a support brace disposed inside the first tubing that is effective to hold the hot surface igniter at the angle that is effective to place the heating element in the path of a fuel/air mixture.

3. The pilot burner igniter apparatus of claim 1, further comprising a fuel pipe disposed within the first tubing, the fuel pipe having a proximal end and a distal end, the proximal end of the fuel pipe located at the proximal end of the first tubing and effective to receive fuel/air mixture and the distal end of the fuel pipe located adjacent to the hot surface igniter disposed inside the first tubing, wherein the fuel pipe is effective to blow fuel/air mixture over the heating element of the hot surface igniter.

4. The pilot burner igniter apparatus of claim 3, wherein the support brace further comprises a notch to receive the fuel pipe.

5. The pilot burner igniter apparatus of claim 1, wherein the first tubing further comprises a threaded region that is effective to be separated by unscrewing and effective to be re-connected by screwing, wherein the threaded region is adjacent to the hot surface igniter and is effective to allow access to the hot surface igniter.

6. The pilot burner igniter apparatus of claim 1, wherein the hot surface igniter is disposed between 1 foot and 5 feet away from the distal end of the first tubing.

7. The pilot burner igniter apparatus of claim 1, wherein the hot surface igniter is disposed between 1 foot and 3 feet away from the distal end of the first tubing.

8. The pilot burner igniter apparatus of claim 1, wherein the hot surface igniter is disposed about 2 feet away from the distal end of the first tubing.

9. The pilot burner igniter apparatus of claim 2, wherein the support brace is effective to hold the hot surface igniter at an angle of between 89-69 degrees relative to the wall of the first tubing.

10. The pilot burner igniter apparatus of claim 2, wherein the support brace is effective to hold the hot surface igniter at an angle of about 79 degree relative to the wall of the first tubing.

11. The pilot burner igniter apparatus of claim 1, wherein the hot surface igniter is effective to ignite and maintain ignition of natural gas/air mixture.

12. A rotary kiln system comprising:
a rotary kiln defining a cylindrical interior chamber that is effective to convey a material from a distal end to a proximal end of the rotary kiln;
a hood disposed on the proximal end of the rotary kiln; and
a pilot burner igniter apparatus, the pilot burner igniter apparatus comprising:
a first tubing having a proximal end and a distal end, the proximal end of the first tubing functional to receive a fuel/air mixture and the distal end of the first tubing functional to allow emission of a flame; and
a hot surface igniter disposed inside the first tubing between the proximal end and the distal end at a position that is directly in the path of the fuel/air mixture, the hot surface igniter comprising a first end and a second end, where the first end is operably connected to a power source and the second end comprises a heating element;
wherein the hot surface igniter is disposed in the first tubing at an angle that is effective to place the heating element in the path of the fuel/air mixture;
wherein the hot surface igniter is disposed inside the first tubing between the proximal end and the distal end at a position that is effective to minimize heating of the hot surface igniter;
wherein the distal end of the first tubing of the pilot burner igniter apparatus is disposed through the hood and adjacent to the proximal end of the rotary kiln and is effective to emit a flame into the proximal end of the rotary kiln.

13. The rotary kiln system of claim 12, wherein the first tubing of the pilot burner igniter apparatus is capable of being moved to different positions through the hood.

14. The rotary kiln system of claim 12, further comprising a support brace disposed inside the first tubing that is effective to hold the hot surface igniter at the angle that is effective to place the heating element in the path of a fuel/air mixture.

15. The rotary kiln system of claim 12, further comprising a fuel pipe disposed within the first tubing, the fuel pipe having a proximal end and a distal end, the proximal end of the fuel pipe located at the proximal end of the first tubing and effective to receive fuel/air mixture, and the distal end of the fuel pipe located adjacent to the hot surface igniter disposed inside the first tubing, wherein the fuel pipe is effective to blow fuel/air mixture over the heating element of the hot surface igniter.

16. The rotary kiln system of claim 15, wherein the support brace further comprises a notch to receive the fuel pipe.

17. The rotary kiln system of claim 12, wherein the first tubing further comprises a threaded region that is effective to be separated by unscrewing and effective to be re-connected by screwing, wherein the threaded region is adjacent to the hot surface igniter and is effective to allow access to the hot surface igniter.

18. The rotary kiln system of claim 12, wherein the hot surface igniter is disposed between 1 foot and 5 feet away from the distal end of the first tubing.

19. The rotary kiln system of claim 12, wherein the hot surface igniter is disposed between 1 foot and 3 feet away from the distal end of the first tubing.

20. The rotary kiln system of claim 12, wherein the hot surface igniter is disposed about 2 feet away from the distal end of the first tubing.

21. The rotary kiln system of claim 14, wherein the support brace is effective to hold the hot surface igniter at an angle of between 89-69 degrees relative to the wall of the first tubing.

22. The rotary kiln system of claim 14, wherein the support brace is effective to hold the hot surface igniter at an angle of about 79 degree relative to the wall of the first tubing.

23. The rotary kiln system of claim 12, wherein the hot surface igniter is effective to ignite and maintain ignition of natural gas/air mixture.

24. A method for production of calcined coke, comprising the steps of charging and conveying coke through the rotary kiln system of claim 12.
